(19) United States
(12) Patent Application Publication
(10) Pub. No.: US 2026/0120970 A1
(43) Pub. Date: Apr. 30, 2026

(54) ELECTRIC SWITCH

(71) Applicant: ABB Schweiz AG, Baden (CH)

(72) Inventors: Jarmo Lehtimäki, Vaasa (FI); Markus Mäki, Seinäjoki (FI)

(21) Appl. No.: 19/371,742

(22) Filed: Oct. 28, 2025

(30) Foreign Application Priority Data
Oct. 29, 2024 (EP) 24209484.5

(51) Int. Cl. H01H 9/36; H01H 1/20; H01H 9/34

(52) U.S. Cl. CPC H01H 9/362; H01H 1/2041; H01H 9/342; H01H 2009/367

(57) ABSTRACT

An electric switch comprising a frame, a first stationary contact, a rotating contact and a plurality of arc extinguisher members is described. The plurality of arc extinguisher members has a guide protrusion system configured to guide an electric arc generated during an opening event of the electric switch to a tortuous path in which the electric arc advances in the plurality of arc extinguisher members in a lateral direction parallel to a rotation axis of the rotating contact thereby lengthening the electric arc. The guide protrusion system comprises a plurality of guide protrusions each protruding from a body part of the corresponding arc extinguisher member towards an adjacent arc extinguisher member and providing the shortest route for the electric arc between the two arc extinguisher members.

### CROSS REFERENCE TO RELATED APPLICATIONS

The present application claims priority to European Patent Application No. 24209484.5 filed on Oct. 29, 2024, and titled “ELECTRIC SWITCH”, which is hereby incorporated by reference in its entirety.

### TECHNICAL FIELD

The present disclosure relates to an electric switch.

### BACKGROUND

An electric switch is a device configured to open and close an electric circuit it is connected to. When an electric circuit is opened by an electric switch, an electric arc whose temperature is thousands of degrees may occur in the electric switch. An electric arc includes ionized gas, which contains a large number of free electrons. Such a gas plasma is electrically conductive.

An electric arc delays transfer of an electric switch from a conducting state to a non-conducting state. Further, an electric arc is often harmful for an electric switch and for an electric assembly comprising the electric switch.

It is known in the art to use arc extinguisher members such as arc extinguisher plates for reducing duration of electric arcs in electric switches. Examples of known electric switches provided with arc extinguisher plates are described in publications EP 3457423 A1, CN113593996A and WO2018086350A1.

### BRIEF DESCRIPTION

An object of the present disclosure is to provide an electric switch which has an improved structure regarding electric arc extinguishing. The objects of the present disclosure are achieved by the subject-matter of the independent claim. Further exemplary embodiments are evident from the dependent claims and the following description. The embodiments and features, if any, described in this specification that do not fall under the scope of the independent claim are to be interpreted as examples useful for understanding various embodiments of the present disclosure.

The present disclosure provides arc extinguisher members of an electric switch with a guide protrusion system configured to guide an electric arc generated during an opening event of the electric switch to a tortuous path in which the electric arc advances in the arc extinguisher members in a lateral direction parallel to a rotation axis of a rotating contact of the electric switch thereby lengthening the electric arc. The guide protrusion system comprises a plurality of guide protrusions each protruding from a body part of the corresponding arc extinguisher member towards an adjacent arc extinguisher member and providing the shortest route for the electric arc between the two arc extinguisher members. Locations of the guide protrusions alternate from one lateral side to the other in order to form the tortuous or meandering path for the electric arc.

An advantage of the electric switch of the present disclosure is that the electric arc is not only longer but it also advances in the arc extinguisher members in the lateral direction thereby further improving cooling of the electric arc.

An aspect relates to an electric switch comprising a frame, a first stationary contact stationarily fixed to the frame, a roll element configured to rotate relative to the frame about a rotation axis between a first position and a second position, a rotating contact stationarily fixed to the roll element, the rotating contact comprising a first contact portion such that in the first position of the roll element the first contact portion is electrically conductively connected to the first stationary contact, and in the second position of the roll element the rotating contact is disconnected from the first stationary contact, and a plurality of arc extinguisher members configured to extinguish an electric arc generated during an opening event between the first stationary contact and the first contact portion of the rotating contact, wherein the plurality of arc extinguisher members is located adjacent to a path of the first contact portion, each of the plurality of arc extinguisher members comprises a body part made of electrically conducting material, the plurality of arc extinguisher members comprises a guide protrusion system configured to guide the electric arc to a tortuous path in which the electric arc advances in the plurality of arc extinguisher members in a lateral direction parallel to the rotation axis thereby lengthening the electric arc, and the guide protrusion system comprises a plurality of guide protrusions each protruding from the body part of the corresponding arc extinguisher member towards an adjacent arc extinguisher member and configured to provide the shortest route for the electric arc between the two arc extinguisher members.

### BRIEF DESCRIPTION OF DRAWINGS

The subject matter of the present disclosure will be explained in more detail in the following text with reference to exemplary embodiments which are illustrated in the attached drawings.

FIG. 1 is a side view of an electric switch according to an embodiment of the present disclosure.

FIG. 2 shows part of the components of the electric switch of FIG. 1 and an electric arc generated during an opening event of the electric switch according to an embodiment of the present disclosure.

FIG. 3 shows a first stationary contact and a plurality of arc extinguisher members of the electric switch of FIG. 1 from a direction oblique relative to a rotation axis of a roll element of the electric switch according to an embodiment of the present disclosure.

FIG. 4 shows a first stationary contact and a plurality of arc extinguisher members of an electric switch according to an alternative embodiment of the present disclosure.

FIG. 5 shows a route of an electric arc through the plurality of arc extinguisher members shown in FIG. 4 according to an embodiment of the present disclosure.

FIG. 6 shows a first arc extinguisher member of the electric switch of FIG. 1 according to an embodiment of the present disclosure.

FIG. 7 shows a second arc extinguisher member of the electric switch of FIG. 1 according to an embodiment of the present disclosure.

FIG. 8 shows the first arc extinguisher member of FIG. 6 from a direction perpendicular to a plane defined by a body part of the first arc extinguisher member, and a cross-section of the first arc extinguisher member along line A-A according to an embodiment of the present disclosure.

FIG. 9 shows a first modification of the first arc extinguisher member according to an embodiment of the present disclosure.

FIG. 10 shows a first modification of the second arc extinguisher member according to an embodiment of the present disclosure.

FIG. 11 shows a route of an electric arc through a plurality of arc extinguisher members comprising the first modifications of the first and second arc extinguisher members shown in FIGS. 9 and 10 according to an embodiment of the present disclosure.

FIG. 12 shows a route of an electric arc through a plurality of arc extinguisher members comprising the first modifications of the second arc extinguisher member shown in FIG. 10 and intermediate arc extinguisher members according to an embodiment of the present disclosure.

FIG. 13 shows a second modification of the first arc extinguisher member according to an embodiment of the present disclosure.

FIG. 14 shows a third modification of the first arc extinguisher member according to an embodiment of the present disclosure.

FIG. 15 shows a fourth modification of the first arc extinguisher member according to an embodiment of the present disclosure.

FIG. 16 shows part of components of an electric switch according to a further embodiment comprising a guide wall system according to an embodiment of the present disclosure.

FIG. 17 is a partial side view of the components shown in FIG. 16 according to an embodiment of the present disclosure.

The reference symbols used in the drawings, and their meanings, are listed in summary form in the list of reference symbols. In principle, identical parts are provided with the same reference symbols in the figures.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. In some instances, the same or similar components may be assigned a different reference number, for example, due to a different configuration within the electronic circuit. Generally, only the differences with respect to the individual embodiments are described. Unless specified otherwise, the description of a part or aspect in one embodiment applies to a corresponding part or aspect in another embodiment as well.

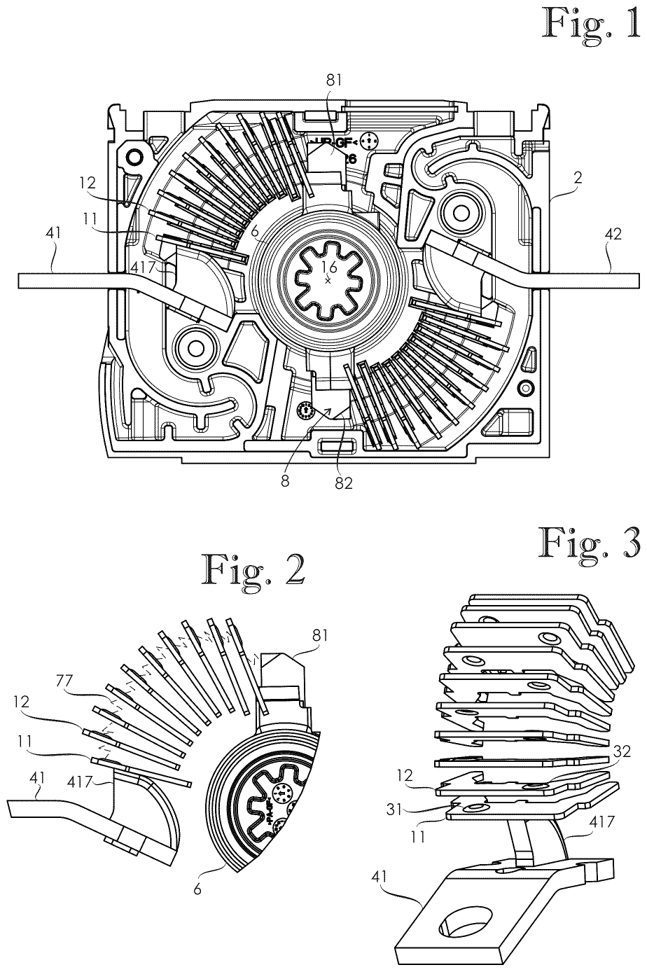

FIG. 1 is a side view of an electric switch according to an embodiment of the present disclosure. The electric switch comprises a frame 2, a first stationary contact 41, a second stationary contact 42, a roll element 6, a rotating contact 8 and a plurality of arc extinguisher members. In FIG. 1, one half of the frame 2 has been omitted in order to show an internal structure of the electric switch.

The first stationary contact 41 is stationarily fixed to the frame 2 and configured to be connected to a power supply. The second stationary contact 42 is stationarily fixed to the frame 2 and configured to be connected to a load. The first stationary contact 41 and the second stationary contact 42 are made of electrically conducting material. The frame 2 is made of electrically insulating material.

The roll element 6 is made of electrically insulating material and is configured to rotate relative to the frame 2 around a rotation axis 16 between a first position and a second position. In FIG. 1, the rotation axis 16 is perpendicular to the image plane.

The rotating contact 8 is stationarily fixed to the roll element 6. The rotating contact 8 is made of electrically conducting material and comprises a first contact portion 81 and a second contact portion 82. Relative to the rotation axis 16, an angular displacement between the first contact portion 81 and second contact portion 82 is 180°.

In the first position of the roll element 6, the first contact portion 81 is electrically conductively connected to the first stationary contact 41 and the second contact portion 82 is electrically conductively connected to the second stationary contact 42. In the second position of the roll element 6, the rotating contact 8 is disconnected from the first stationary contact 41 and from the second stationary contact 42. In an embodiment, an angular displacement between the first position of the roll element and the second position of the roll element is greater than or equal to 90°.

The roll element 6 is configured to rotate from the first position to the second position in an opening event of the electric switch. The opening event is configured to break the electrically conductive connection between the first stationary contact 41 and the second stationary contact 42.

The plurality of arc extinguisher members is configured for extinguishing electric arcs generated during an opening event between the first stationary contact 41 and the first contact portion 81 of the rotating contact 8, and between the second stationary contact 42 and the second contact portion 82 of the rotating contact 8. Extinguishing the electric arc between the first stationary contact 41 and the first contact portion 81 takes place in the same way as extinguishing the electric arc between the second stationary contact 42 and the second contact portion 82.

For sake of conciseness, only extinguishing the electric arc generated during the opening event between the first stationary contact 41 and the first contact portion 81 of the rotating contact 8 is explained in detail herein. Therefore, the plurality of arc extinguisher members refers hereafter to those arc extinguisher members that are configured for extinguishing the electric arc between the first stationary contact 41 and the first contact portion 81 of the rotating contact 8.

The plurality of arc extinguisher members is located adjacent to a path along which a free end of the first contact portion 81 moves during beginning of the opening event. Each of the plurality of arc extinguisher members comprises a substantially planar body part made of electrically conducting material. The plurality of arc extinguisher members is arranged in a “fan shape” such that planes defined by the substantially planar body parts of the arc extinguisher members intercept each other at locations adjacent to the rotation axis 16.

In FIG. 1, there are five first arc extinguisher members 11 and five second arc extinguisher members 12 adjacent to the path along which the free end of the first contact portion 81 moves during beginning of the opening event. The first arc extinguisher members 11 and the second arc extinguisher members 12 alternate in a circumferential direction relative to the rotation axis 16.

FIG. 2 shows part of the components of the electric switch of FIG. 1 and an electric arc 77 generated between the first stationary contact 41 and the first contact portion 81 of the rotating contact 8 during the opening event of the electric switch. FIG. 2 is a side view such that the image plane is perpendicular to the rotation axis 16.

FIG. 3 shows the first stationary contact 41 and the plurality of arc extinguisher members of the electric switch from a direction oblique relative to the rotation axis 16. FIG. 3 shows that the guide protrusion system comprises a first guide protrusion 31 on a first lateral portion of each first arc extinguisher member 11 and a second guide protrusion 32 on a second lateral portion of each second arc extinguisher member 12, wherein the first lateral portion and the second lateral portion are located on opposite sides of a center plane perpendicular to the rotation axis 16. Each first guide protrusion 31 and each second guide protrusion 32 are configured to provide the shortest route from the arc extinguisher member provided with the guide protrusion to the next arc extinguisher member in the direction of the electric arc such that the guide protrusion system is configured for lengthening the electric arc. Both the first guide protrusion 31 and the second guide protrusion 32 protrude from the body part of the corresponding arc extinguisher member in the circumferential direction. The arc extinguisher members are spaced apart from each other in the circumferential direction.

In FIG. 2, the direction of the electric arc is clockwise. FIG. 2 shows that the guide protrusion system is located farther from the rotation axis 16 than the free end of the first contact portion 81 thereby lengthening the electric arc 77 by increasing a radius of the electric arc 77.

In FIG. 3, the first lateral portions are on the left and the second lateral portions are on the right. The plurality of arc extinguisher members is located symmetrically relative to the center plane such that the center plane divides each arc extinguisher member into two portions having equal widths. The center plane passes through an arc section 417 of the first stationary contact 41, wherein the arc section 417 is a section from which the electric arc 77 is configured to transfer to the plurality of arc extinguisher members during the opening event.

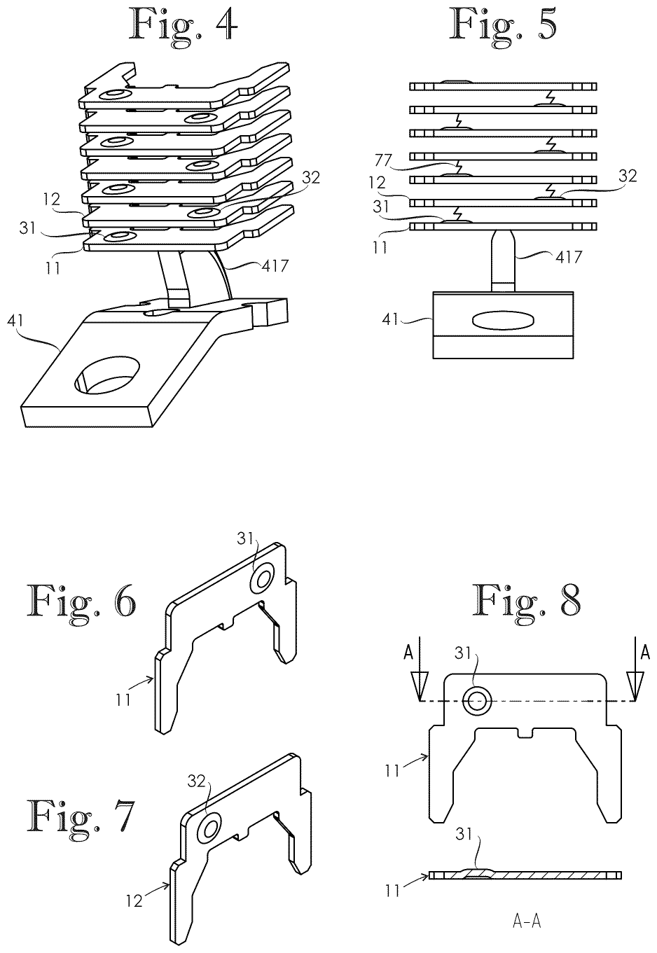

FIG. 4 shows a first stationary contact 41 and a plurality of arc extinguisher members of an electric switch according to an alternative embodiment of the present disclosure. In FIG. 4, the plurality of arc extinguisher members is stacked such that planes defined by the substantially planar body parts of the arc extinguisher members are parallel to each other.

FIG. 5 shows a route of an electric arc 77 through the plurality of arc extinguisher members shown in FIG. 4. The image plane of FIG. 5 is perpendicular to the planes defined by the substantially planar body parts of the arc extinguisher members. In FIG. 5, the electric arc 77 advances through a route the form of which resembles a rectangular wave.

FIG. 6 shows the first arc extinguisher member 11 as a separate component, and FIG. 7 shows the second arc extinguisher member 12 as a separate component. FIG. 8 shows the first arc extinguisher member 11 from a direction perpendicular to a plane defined by a body part of the first arc extinguisher member 11, and a cross-section of the first arc extinguisher member 11 along line A-A. Except for the locations of the guide protrusions, the first arc extinguisher member 11 and the second arc extinguisher member 12 are identical to each other.

The first guide protrusion 31 protrudes from the body part of the first arc extinguisher member 11 in a direction perpendicular to the plane defined by the planar body. The second guide protrusion 32 protrudes from the body part of the second arc extinguisher member 12 in a direction perpendicular to the plane defined by the planar body. On planes parallel to the plane defined by the planar body of the arc extinguisher member, the guide protrusions 31 and 32 have circular cross-sections.

The plurality of arc extinguisher members is made of sheet metal. The guide protrusion system is an integral part of the plurality of arc extinguisher members. The guide protrusion system is made by a forming process through mechanical deformation.

Both the first guide protrusion 31 and the second guide protrusion 32 are closed protrusions such that they do not provide a hole through the corresponding arc extinguisher member. The first guide protrusion 31 and the second guide protrusion 32 are identical protrusions.

Both the first guide protrusion 31 and the second guide protrusion 32 protrude from the body part of corresponding arc extinguisher member 0.75 mm, and thickness of the body part is 1.5 mm. In an alternative embodiment, each of the plurality of guide protrusions protrudes from the body part of corresponding arc extinguisher member at least 0.4 mm in a direction perpendicular to a plane defined by the body part. Thickness of the body part of each arc extinguisher member is in the range of 1.0-3.0 mm.

In an embodiment, for each of the plurality of guide protrusions, on a plane defined by the body part of the arc extinguisher member from which the guide protrusion protrudes from, a surface area of a projection of the guide protrusion is greater than or equal to 2% of a surface area of a projection of the arc extinguisher member.

In another embodiment, for each of the plurality of guide protrusions, on a plane defined by the body part of the arc extinguisher member from which the guide protrusion protrudes from, a surface area of a projection of the guide protrusion is greater than or equal to 5% of a surface area of a projection of an outer section of the arc extinguisher member, wherein the outer section of the arc extinguisher member is located radially outwards relative to the rotating contact. In other words, the outer section of an arc extinguisher member is located radially outwards relative to a right circular cylinder whose center line coincides with the rotating axis, radius is equal to a distance of the free end of the first contact portion of the rotating contact from the rotating axis, and height is infinite.

In an embodiment, a center point of each guide protrusion is located on a side portion of the outer section of the arc extinguisher member, wherein a lateral distance of the side portion from a center point of the arc extinguisher member is greater than or equal to 25% of a lateral dimension of the outer section of the arc extinguisher member.

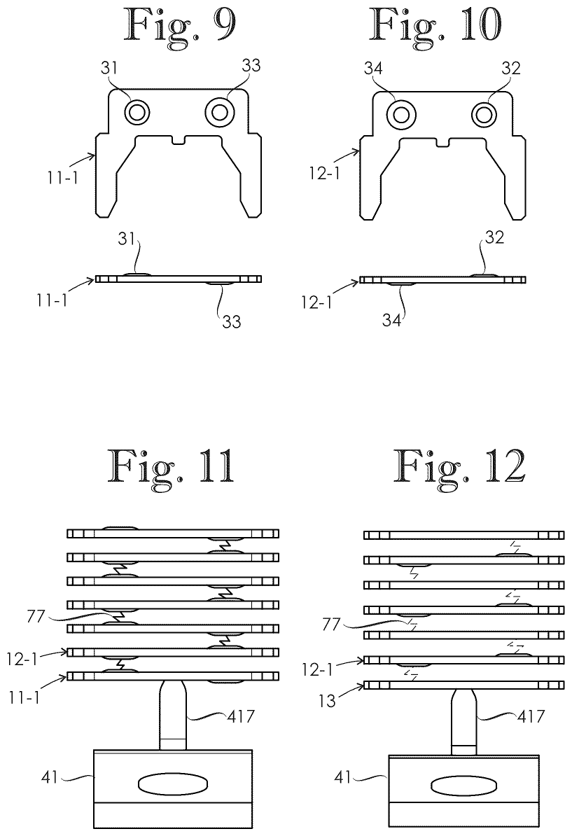

FIG. 9 shows a first modification 11-1 of the first arc extinguisher member which comprises a first guide protrusion 31 on a first lateral portion of the first modification 11-1 of the first arc extinguisher member, and a third guide protrusion 33 on a second lateral portion of the first modification 11-1 of the first arc extinguisher member, wherein the first lateral portion and the second lateral portion are located on opposite sides of a center plane perpendicular to the rotation axis. The first guide protrusion 31 and the third guide protrusion 33 protrude in opposite directions from the body part of the first modification 11-1 of the first arc extinguisher member. The electric arc is configured to enter the first modification 11-1 of the first arc extinguisher member through the third guide protrusion 33, and to leave the first modification 11-1 of the first arc extinguisher member through the first guide protrusion 31.

The first guide protrusion 31 and the third guide protrusion 33 are identical protrusions. Except for the third guide protrusion 33, the first modification 11-1 of the first arc extinguisher member is identical to first arc extinguisher member 11 shown in FIG. 6.

FIG. 10 shows a first modification 12-1 of the second arc extinguisher member which comprises a fourth guide protrusion 34 on a first lateral portion of the first modification 12-1 of the second arc extinguisher member, and a second guide protrusion 32 on a second lateral portion of the first modification 12-1 of the second arc extinguisher member, wherein the first lateral portion and the second lateral portion are located on opposite sides of a center plane perpendicular to the rotation axis. The second guide protrusion 32 and the fourth guide protrusion 34 protrude in opposite directions from the body part of the first modification 12-1 of the second arc extinguisher member. The second guide protrusion 32 and the fourth guide protrusion 34 are identical protrusions. Except for the fourth guide protrusion 34, the first modification 12-1 of the second arc extinguisher member is identical to second arc extinguisher member 12 shown in FIG. 7.

FIG. 11 shows a route of an electric arc 77 through a plurality of arc extinguisher members in which the first modifications 11-1 of the first arc extinguisher member and the first modifications 12-1 of the second arc extinguisher member alternate. FIG. 11 shows that the electric arc 77 transfers from the first guide protrusion 31 of the first modification 11-1 of the first arc extinguisher member to a fourth guide protrusion 34 of a first modification 12-1 of the second arc extinguisher member. From the first modification 12-1 of the second arc extinguisher member, the electric arc 77 transfers through the second guide protrusion 32 of the first modifications 12-1 of the second arc extinguisher member to the third guide protrusion 33 of the next first modification 11-1 of the first arc extinguisher member.

FIG. 12 shows a route of an electric arc 77 through a plurality of arc extinguisher members in which first modifications 12-1 of the second arc extinguisher member and intermediate arc extinguisher members 13 alternate. Each intermediate arc extinguisher member 13 is an arc extinguisher member with no guide protrusion. Except for the omitted guide protrusions, the intermediate arc extinguisher member 13 is identical to the first arc extinguisher member 11 and the second arc extinguisher member 12.

In FIG. 12, the electric arc 77 transfers from an intermediate arc extinguisher member 13 to a fourth guide protrusion 34 of a first modification 12-1 of the second arc extinguisher member. From the first modification 12-1 of the second arc extinguisher member, the electric arc 77 transfers through the second guide protrusion 32 of the first modifications 12-1 of the second arc extinguisher member to the next intermediate arc extinguisher member 13.

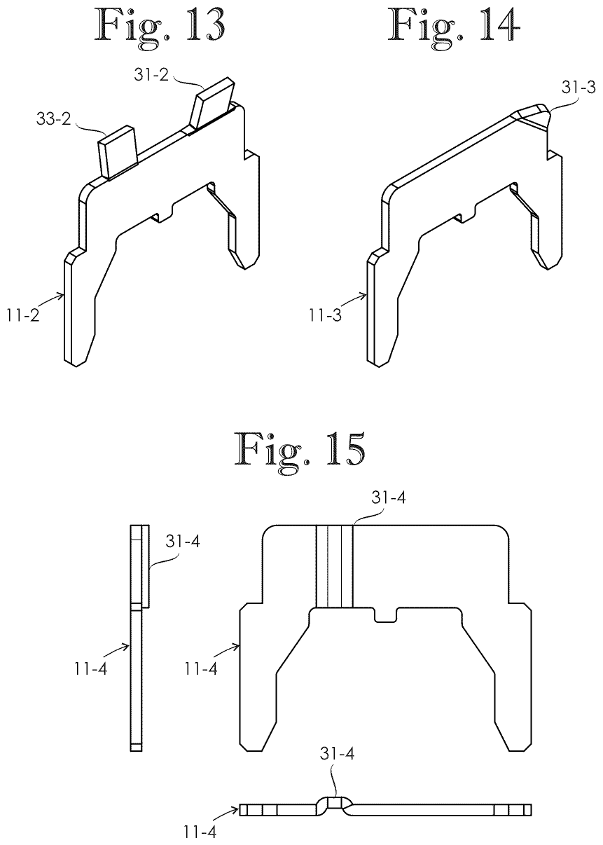

FIG. 13 shows a second modification 11-2 of the first arc extinguisher member. A first guide protrusion 31-2 protrudes from the body part of the second modification 11-2 of the first arc extinguisher member 11-2 in a direction perpendicular to the plane defined by the planar body. A third guide protrusion 33-2 protrudes from the body part of the second modification 11-2 of the first arc extinguisher member 11-2 in the direction perpendicular to the plane defined by the planar body.

The first guide protrusion 31-2 is formed by providing a first protrusion on the body part of the second modification 11-2 of the first arc extinguisher member 11-2 and bending the first protrusion in a first direction. The third guide protrusion 33-2 is formed by providing a second protrusion on the body part of the second modification 11-2 of the first arc extinguisher member 11-2 and bending the second protrusion in a second direction opposite to the first direction. Both the first guide protrusion 31-2 and the third guide protrusion 33-2 are located on a distal edge of the body part. The distal edge of the body part is an edge located farthermost from the rotation axis. Except for the guide protrusions, the second modification 11-2 of the first arc extinguisher member is identical to the intermediate arc extinguisher member 13.

FIG. 14 shows a third modification 11-3 of the first arc extinguisher member. A first guide protrusion 31-3 protrudes from the body part of the third modification 11-3 of the first arc extinguisher member in a direction perpendicular to the plane defined by the planar body. The first guide protrusion 31-3 is formed by bending a distal corner of the body part in a first direction. The distal corner of the body part is a corner far from the rotation axis and far from the center plane.

Except for the first guide protrusion 31-3, the third modification 11-3 of the first arc extinguisher member is identical to the intermediate arc extinguisher member 13. It is possible to manufacture the third modification 11-3 of the first arc extinguisher member from the intermediate arc extinguisher member 13 by bending a distal corner of the body part in a first direction.

FIG. 15 shows a fourth modification 11-4 of the first arc extinguisher member. A first guide protrusion 31-4 protrudes from the body part of the fourth modification 11-4 of the first arc extinguisher member in a direction perpendicular to the plane defined by the planar body. On a plane parallel to the plane defined by the planar body of the fourth modification 11-4 of the first arc extinguisher member, the first guide protrusion 31-4 has a rectangular cross-section. The first guide protrusion 31-4 is a crease or fold that extends through the body part of the fourth modification 11-4 of the first arc extinguisher member in a direction perpendicular to the rotation axis.

The first guide protrusion 31-4 is provided on a portion of the body part that is located farther from the rotation axis than the free end of the first contact portion. Therefore, the entire first guide protrusion 31-4 is located farther from the rotation axis than the free end of the first contact portion.

Except for the first guide protrusion 31-4, the fourth modification 11-4 of the first arc extinguisher member is identical to the intermediate arc extinguisher member 13. It is possible to manufacture the fourth modification 11-4 of the first arc extinguisher member from the intermediate arc extinguisher member 13 by forming a linear crease to the body part of intermediate arc extinguisher member 13.

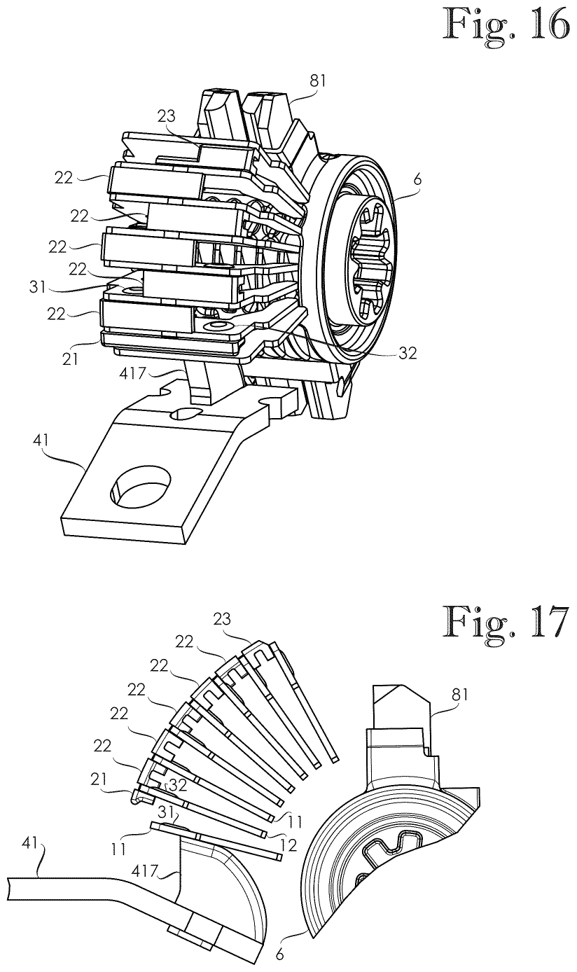

FIG. 16 shows part of components of an electric switch according to a further embodiment comprising a guide wall system, and FIG. 17 is a partial side view of the components shown in FIG. 16.

In the embodiment of FIG. 16, the plurality of arc extinguisher members comprises four first arc extinguisher members 11 and four second arc extinguisher member 12 such that the first arc extinguisher members 11 and the second arc extinguisher members 12 alternate in the direction of the electric arc. The guide wall system is configured to guide a gas flow inside the frame during the opening event in order to increase probability that the electric arc advances through the guide protrusion system. The gas flow is inherently generated by the electric arc. The guide wall system comprises a start guide wall segment 21, five intermediate guide wall segments 22 and an end guide wall segment 23.

Each intermediate guide wall segment 22 is located between two successive arc extinguisher members and configured to obstruct a radially outwards directed gas flow between the successive arc extinguisher members in locations spaced apart from a desired arc position while allowing the radially outwards directed gas flow adjacent to the desired arc position, wherein the desired arc position is a position in which the guide protrusion system is configured to provide the shortest route between the successive arc extinguisher members. Owing to the intermediate guide wall segment 22, the gas flow guides the electric arc to the position of the guide protrusion in the lateral direction, and outwards in the radial direction perpendicular to the rotation axis. In other words, by utilizing the gas flow inherently generated by the electric arc, the guide wall system ensures that the electric arc is guided to an optimal position in the plurality of arc extinguisher members.

In the beginning of an electric arc, the electric arc transfers from the first stationary contact to the nearest arc extinguisher member, and later the electric arc transfers from the last arc extinguisher member of the group to the first contact portion of the rotating contact. Both the transition from the first stationary contact and the transition to the first contact portion of the rotating contact are different from transitions between the arc extinguisher members. Therefore, the start guide wall segment 21 and the end guide wall segment 23 are different from the intermediate guide wall segments 22. Further, the start guide wall segment 21 is different from the end guide wall segment 23. It should be noticed that in the embodiment of FIG. 16, the first arc extinguisher member of the plurality of arc extinguisher members is located radially more inward than the rest of the arc extinguisher members, which also affects the design of the start guide wall segment 21.

The guide wall system is an integral part of the frame of the electric switch such that the start guide wall segment 21, the intermediate guide wall segments 22 and the end guide wall segment 23 have been manufactured by the same process as the frame. In an embodiment, said process is an injection molding process.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practicing the present disclosure, from a study of the drawings, the disclosure, and the appended claims. In the claims, the word “comprising” does not exclude other elements or activities, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. An electric switch comprising:
a frame;
a first stationary contact stationarily fixed to the frame;
a roll element configured to rotate relative to the frame about a rotation axis between a first position and a second position;
a rotating contact stationarily fixed to the roll element, the rotating contact comprising a first contact portion such that in the first position of the roll element the first contact portion is electrically conductively connected to the first stationary contact and in the second position of the roll element the rotating contact is disconnected from the first stationary contact; and
a plurality of arc extinguisher members configured to extinguish an electric arc generated during an opening event between the first stationary contact and the first contact portion of the rotating contact wherein:
the plurality of arc extinguisher members is located adjacent to a path of the first contact portion,
each of the plurality of arc extinguisher members comprises a body part made of electrically conducting material,
the plurality of arc extinguisher members comprises a guide protrusion system configured to guide the electric arc to a tortuous path in which the electric arc advances in the plurality of arc extinguisher members in a lateral direction parallel to the rotation axis thereby lengthening the electric arc, and
the guide protrusion system comprises a plurality of guide protrusions each protruding from the body part of the corresponding arc extinguisher member towards an adjacent arc extinguisher member and configured to provide the shortest route for the electric arc between the two arc extinguisher members.

2. The electric switch according to claim 1, wherein the guide protrusion system is located farther from the rotation axis than the first contact portion of the rotating contact.

3. The electric switch according to claim 1, wherein the guide protrusion system is an integral part of the plurality of arc extinguisher members.

4. The electric switch according to claim 1, wherein the plurality of arc extinguisher members is made of sheet metal.

5. The electric switch according to claim 4, wherein the guide protrusion system is made by a forming process through mechanical deformation.

6. The electric switch according to claim 1, wherein each guide protrusion protrudes from the body part of the corresponding arc extinguisher member in a direction perpendicular to a plane defined by the body part.

7. The electric switch according to claim 1, wherein:
the guide protrusion system further comprises a plurality of guide protrusions on one side of a center plane perpendicular to the rotation axis and a plurality of guide protrusions on the other side of the center plane such that the center plane passes through an arc section of the first stationary contact, and
the arc section is a section from which the electric arc is configured to transfer to the plurality of arc extinguisher members during the opening event.

8. The electric switch according to claim 1, wherein each of the plurality of guide protrusions protrudes from the body part of the corresponding arc extinguisher member at least 0.4 mm in a direction perpendicular to a plane defined by the body part.

9. The electric switch according to claim 1, wherein each of the plurality of guide protrusions is a closed protrusion.

10. The electric switch according to claim 1, wherein, for each of the plurality of guide protrusions, on a plane defined by the body part of the arc extinguisher member from which the guide protrusion protrudes from, a surface area of a projection of the guide protrusion is greater than or equal to 2% of a surface area of a projection of the arc extinguisher member.

11. The electric switch according to claim 1, wherein:
for each of the plurality of guide protrusions, on a plane defined by the body part of the arc extinguisher member from which the guide protrusion protrudes from, a surface area of a projection of the guide protrusion is greater than or equal to 5% of a surface area of a projection of an outer section of the arc extinguisher member, and
the outer section of the arc extinguisher member is located radially outwards relative to the rotating contact.

12. The electric switch according to claim 1, wherein the electric switch has a guide wall system configured to guide a gas flow generated by the electric arc during the opening event in order to increase a probability that the electric arc advances through the guide protrusion system.

13. The electric switch according to claim 12, wherein:
the guide wall system comprises a plurality of intermediate guide wall segments each located between two successive arc extinguisher members and configured to obstruct a radially outwards directed gas flow between the successive arc extinguisher members in a location laterally spaced apart from a desired arc position while allowing the radially outwards directed gas flow adjacent the desired arc position, and
the desired arc position is a position in which the guide protrusion system is configured to provide the shortest route between the successive arc extinguisher members.

14. The electric switch according to claim 12, wherein the guide wall system is an integral part of the frame.

15. The electric switch according to claim 2, wherein the guide protrusion system is an integral part of the plurality of arc extinguisher members.

16. The electric switch according to claim 2, wherein the plurality of arc extinguisher members is made of sheet metal.

17. The electric switch according to claim 2, wherein each guide protrusion protrudes from the body part of the corresponding arc extinguisher member in a direction perpendicular to a plane defined by the body part.

18. The electric switch according to claim 2, wherein:
the guide protrusion system further comprises a plurality of guide protrusions on one side of a center plane perpendicular to the rotation axis, and a plurality of guide protrusions on the other side of the center plane such that the center plane passes through an arc section of the first stationary contact, and
the arc section is a section from which the electric arc is configured to transfer to the plurality of arc extinguisher members during the opening event.

19. The electric switch according to claim 2, wherein each of the plurality of guide protrusions protrudes from the body part of the corresponding arc extinguisher member at least 0.4 mm in a direction perpendicular to a plane defined by the body part.

20. The electric switch according to claim 2, wherein each of the plurality of guide protrusions is a closed protrusion.
